(19) United States
(12) Patent Application Publication
(10) Pub. No.: US 2019/0264674 A1
(43) Pub. Date: Aug. 29, 2019

(54) Subsea Charge Pump

(71) Applicant: Oceaneering International, Inc., Houston, TX (US)

(72) Inventors: Sam Almerico, The Woodlands, TX (US); Christopher Leon, Cypress, TX (US); Skip Smith, Houston, TX (US)

(73) Assignee: Oceaneering International, Inc., Houston, TX (US)

(21) Appl. No.: 16/289,375

(22) Filed: Feb. 28, 2019

Related U.S. Application Data
(60) Provisional application No. 62/636,528, filed on Feb. 28, 2018.

(51) Int. Cl. F04B 47/06; F04B 43/00; F04B 49/22

(52) U.S. Cl. CPC F04B 47/06; F04B 43/009; F05B 2270/3011; F04B 2205/01; F04B 2207/02; F04B 49/22

(57) ABSTRACT

Fluid charging system can provide a higher inlet pressure than the ambient pressure for pumps intended to operated and comprises one or more subsea fluid reservoirs; one or more charge pumps configured to provide an output pressure higher than ambient pressure; various fluid conduits in fluid communication with the subsea fluid reservoirs and charge pumps; and various valves. Fluid is provided to a bladder at a first fluid pressure and fluid charging system used to provide protection for the subsea fluid reservoir and inlet conditions of the subsea pump. A second valve is used to protect the subsea fluid reservoir from pressure leaking back and a feedback loop used to protect inlet conditions of the subsea pump by setting the feedback loop valve to open near the maximum inlet condition.

### RELATION TO OTHER APPLICATIONS

This application claims priority through U.S. Provisional Application 62/636,528 filed on 28 Feb. 2018.

### BACKGROUND

Many forms of pumps require a specific amount of net positive suction head (NPSH) to operate correctly and prevent cavitation. In any operation, fluid flows from areas of high pressure to areas of low pressure. Pumps in the same fashion operate by creating a low pressure condition at the inlet of the pumps which allows fluid to be pushed into the pump by atmospheric pressure or head pressure.

In a topside air environment, increasing the pressure to the pump inlet is done by raising the level of the supply fluid above the pump to create sufficient NPSH for the pump. However, in a subsea environment this practice cannot be replicated as the ambient fluid seawater is of similar density to the process fluid and therefore does not allow for differences in height to produce sufficient increase in pressure. Additionally, most subsea reservoirs are made from flexible material which cannot maintain pressure differences between the fluid outside and inside the tank. Internal pressure boosting is also difficult as the flexible membrane between the process fluid and the ambient fluid may not be able to handle a large pressure differential.

Further complicating the issue is that specific types of pumps in a subsea environment worsen this condition. Many pumps are protected from hydrostatic pressure by either utilizing an extremely thick and heavy housing to withstand external hydrostatic pressure or utilizing a compensator. Compensators apply ambient hydrostatic pressure to the interior of an assembly, say, a hydraulic reservoir of a pump via a small bladder and a spring which is external to pump. In many instances this concept further raises the required NPSH of pump as the internal pressure of the pump and inlet is now higher than the ambient pressure.

In general, some types of subsea pumps may require high inlet pressure as they are not able to pull a vacuum. In this scenario, a charge pump can be utilized to increase the suction line pressure to get the pump to operate correctly subsea.

### FIGURES

Various figures are included herein which illustrate aspects of embodiments of the disclosed inventions.

FIG. 1 is a block diagram of an exemplary embodiment of the claimed invention.

### DESCRIPTION OF EXEMPLARY EMBODIMENTS

It is noted that a majority of process fluids used subsea typically have a pressure in and around the specific gravity of seawater. A few cases, such as methanol, deviate from this.

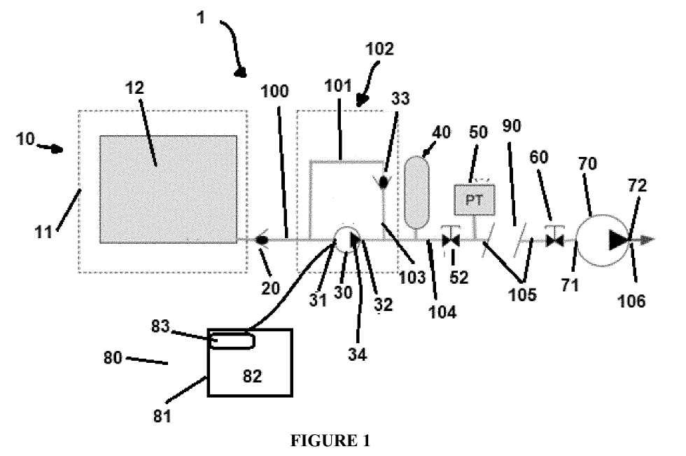

In a first embodiment, referring generally to FIG. 1, fluid charging system 1 comprises one or more subsea fluid reservoirs 10; charge pump 30, comprising charge pump fluid inlet 31 and charge pump fluid outlet 32, configured to provide an output pressure higher than ambient pressure; first fluid conduit 100 in fluid communication with subsea fluid reservoir 10 and charge pump fluid inlet 31; first valve 33 in fluid communication with charge pump fluid outlet 32 where first valve 33 is configured to prevent over-pressurization of an inlet circuit such as one comprising first fluid conduit 100 and/or first feedback fluid conduit 101; second valve 20 disposed intermediate subsea fluid reservoir 10 and charge pump fluid inlet 31 where second valve 20 is in fluid communication with first fluid conduit 100 and configured to prevent pressure from entering subsea fluid reservoir 10 and its bladder 12, as bladder 12 cannot typically take large differentials; second fluid conduit 104 in fluid communication with charge pump fluid outlet 32; feedback loop 102; and one or more controllers 80.

In typical embodiments, each subsea fluid reservoir 10 comprises housing 11 and bladder 12 which comprises fluid typically at ambient pressure.

In typical embodiments, charge pump 30, which has an ability to pull a vacuum and provide an output pressure of around 15 to around 30 psi (1-2 bar above the ambient seawater pressure), may comprise a gear pump, a positive displacement pump, a solenoid operated pump, a centrifugal pump, a diaphragm pump, or the like. Typically, charge pump 30 comprises motor 34 which is configured to drive charge pump 30 where charge pump 30 is mechanically or magnetically coupled to motor 34. Motor 34 may comprise a brushless DC motor, a hydraulic motor, a single phase AC motor, a multiphase AC motor, or the like. In certain embodiments, motor 34 comprises a motor housed in a dielectric fluid filled housing and/or motor housed in a one atmosphere (1 atm) housing.

In typical embodiments, feedback loop 102, which acts as a recirculation loop in the event of over pressurization, comprises first feedback fluid conduit 101 which is in fluid communication with charge pump fluid inlet 31 and with first fluid conduit 100; second feedback fluid conduit 103 which is in fluid communication with charge pump fluid outlet 32 and second fluid conduit 104; and first valve 33 which is in fluid communication with first feedback fluid conduit 101 and second feedback fluid conduit 103. Typically as well, first valve 33, which acts as a feedback loop check or relief valve, is disposed intermediate first feedback fluid conduit 101 and second feedback fluid conduit 103. It is noted that fluid in first fluid conduit 100 and first feedback fluid conduit 101 are typically at or around ambient pressure and the fluid in second feedback fluid conduit 103 is typically at or around charging pressure which can be around ten to twenty five psid.

Each controller 80 typically comprises housing 81, power source 83 operatively in communication with charge pump 30; and controls 82 which are disposed within housing 81 and operatively in communication with the charge pump 30. Controller 80 may be used to provide speed control to dial in flowrates as needed or as charge pump 30 loses efficiency over time. Controls 82 are typically disposed in a compensated oil filled or one atmosphere housing 81.

Fluid in first fluid conduit 100 may be at ambient pressure but fluid in second fluid conduit 104 is at a charged pressure which is greater than pressure in first fluid conduit, e.g. greater than ambient pressure such as having a fluid pressure of around 15 to 30 psi (1-2 bar above the ambient seawater).

In certain embodiments, one or more subsea pumps 70 may be present and disposed downstream from, and in fluid communication with, charge pump 30 via charge pump fluid outlet 32. Typically, each subsea pump 70 comprises subsea pump fluid inlet 71 and subsea pump fluid outlet 72 which is in fluid communication with third fluid conduit 106. Fluid in third fluid conduit 106 is typically at a fluid pressure greater than the charged pressure of fluid in second fluid conduit 104.

In alternative embodiments where subsea pump 70 is part of the configuration, one or more accumulators 40 may be present and disposed downstream of charge pump 30 intermediate subsea pump 70 and charge pump 30 where accumulator 70 is in fluid communication with charge pump fluid outlet 32. In such embodiments, one or more pressure transducers 50 may be present and operatively in communication with an associated accumulator 40 and controller 80. Each pressure transducer 50 is generally operative to provide a signal to controller 80 as to when controller 80 should turn on charge pump 30 to recharge accumulator 40 upon depletion of pressure within accumulator 40 to a predetermined pressure.

If subsea pump 70 is present, control valve 60 may be disposed intermediate subsea pump 70 and charge pump 30 where control valve 60 is operative to open or close fluid delivery to subsea pump 70 from charge pump 30 such as via charged pressure fluid conduit 105. Control valve 60 may be a remotely operated vehicle valve, an electrically actuated valve, or the like.

In certain currently contemplated embodiments, stepout 90 may be disposed intermediate, and in fluid communication with, charge pump outlet 32 and subsea pump 70. Stepout 90 may comprise a hose, a hydraulic flying lead with mechanical connections being made with a hotstab or coupler arrangement, or the like, or a combination thereof, such as charged pressure fluid conduit 105.

In the operation of exemplary embodiments, fluid charging system 1, which is as described above, may be used to provide adequate suction pressure for a pump inlet for a variety of flow rates and pressures. Fluid in bladder 12 is provided from a fluid source (not shown in the figures) and fluid charging system 1 used to provide protection for subsea fluid reservoir 10 and inlet conditions of subsea pump 30. First valve 33 protects its associated subsea fluid reservoir 10 from pressure leaking back.

Feedback loop 102 is used to protect inlet conditions of subsea pump 30 by setting first valve 33 to open near a maximum inlet condition. First valve 33 may be used to provide pressure protection in case first valve 33 is closed and charge pump 30 is run.

Charge pump 30 may comprise a charge pump configured to overcome a large pressure drop due to a long distance between subsea fluid reservoir 10 and charge pump fluid inlet 31 or a large set of restrictions or elbows and turns.

Charge pump 30 may also be used to directly charge accumulator 40 to minimize charge pump runtime.

With the circuit fully open, higher inlet pressures are delivered to subsea pump 70. Each charge pump 30 can be configured to deliver a variety of flowrates and pressure to subsea pump 70 depending on the application requirements. In general, these rates will consist of very low (less than around 0.1 GPM) to very high volumes (around 90 GPM).

The foregoing disclosure and description of the inventions are illustrative and explanatory. Various changes in the size, shape, and materials, as well as in the details of the illustrative construction and/or an illustrative method may be made without departing from the spirit of the invention.

1. A fluid charging system, comprising:
a. a subsea fluid reservoir, comprising:
i. a housing; and
ii. a bladder at ambient pressure, disposed within the housing;
b. a charge pump configured to provide an output pressure higher that ambient pressure, comprising:
i. a charge pump fluid inlet; and
ii. a charge pump fluid outlet;
c. a first fluid conduit in fluid communication with the subsea fluid reservoir and the charge pump fluid inlet;
d. a second valve disposed intermediate the subsea fluid reservoir and the charge pump fluid inlet and in fluid communication with the first fluid conduit, the second valve configured to prevent pressure from entering the subsea fluid reservoir;
e. a second fluid conduit in fluid communication with the charge pump fluid outlet;
f. a feedback loop, comprising:
i. a first feedback fluid conduit in fluid communication with the charge pump fluid inlet and with the first fluid conduit;
ii. a second feedback fluid conduit in fluid communication with the charge pump fluid outlet and the second fluid output; and
iii. a first valve in fluid communication with the charge pump fluid outlet and the charge pump fluid inlet and configured to prevent over-pressurization of an inlet circuit, the first valve in fluid communication with the first feedback fluid conduit and the second feedback fluid conduit and disposed intermediate the first feedback fluid conduit and the second feedback fluid conduit; and
g. a controller, comprising:
i. a housing;
ii. a power source operatively in communication with the charge pump; and
iii. controls disposed within the housing, the controls operatively in communication with the charge pump.

2. The fluid charging system of claim 1, wherein:
a. fluid in the first fluid conduit is at ambient pressure; and
b. fluid in the second fluid conduit is at a charged pressure which is greater than ambient pressure.

3. The fluid charging system 1 of claim 1, further comprising:
a. a subsea pump disposed downstream from the charge pump and in fluid communication with the charge pump fluid outlet, the subsea pump comprising a subsea pump fluid inlet and a subsea pump fluid outlet; and
b. a third fluid conduit in fluid communication with the subsea pump fluid outlet.

4. The fluid charging system 1 of claim 3, wherein fluid in the third fluid conduit (106) is at a fluid pressure greater than the charged pressure.

5. The fluid charging system of claim 3, further comprising:
a. an accumulator disposed intermediate the subsea pump and the charge pump and in fluid communication with the charge pump fluid outlet; and
b. a pressure transducer operatively in communication with the accumulator and the controller, the pressure transducer operative to provide a signal to the controller when the controller should turn on the charge pump to recharge the accumulator upon depletion of the accumulator to a predetermined pressure.

6. The fluid charging system of claim 3, further comprising a control valve disposed intermediate the subsea pump and the charge pump, the control valve operative to open or close fluid delivery to the subsea pump from charge pump.

7. The fluid charging system of claim 6, wherein the control valve comprises a remotely operated vehicle valve or an electrically actuated valve.

8. The fluid charging system of claim 3, further comprising a stepout disposed intermediate and in fluid communication with the charge pump outlet and the subsea pump.

9. The fluid charging system of claim 8, wherein the stepout comprises a hose or hydraulic flying lead with mechanical connections configured to be made with a hotstab or coupler.

10. The fluid charging system of claim 1, wherein the charge pump comprises a gear pump, a positive displacement pump, a solenoid operated pump, a centrifugal pump, or a diaphragm pump.

11. The fluid charging system of claim 1, wherein the charge pump comprises a motor configured to drive the charge pump.

12. The fluid charging system of claim 11, wherein the motor comprises a brushless DC motor, a hydraulic motor, or a single phase AC motor, or a multiphase AC motor.

13. The fluid charging system of claim 11, wherein the charge pump is mechanically or magnetically coupled to the motor.

14. The fluid charging system of claim 11, wherein the motor comprises a motor housed in a dielectric fluid filled housing or motor housed in a 1 atm housing.

15. The fluid charging system of claim 1, wherein the charge pump comprises a charge pump housed in a dielectric fluid filled housing or a charge pump housed in a 1 atm housing.

16. A method of using a fluid charging system 1 which comprises a subsea fluid reservoir 10 comprising a housing and a bladder at ambient pressure, disposed within the housing, a charge pump configured to provide an output pressure higher that ambient pressure and comprising a charge pump fluid inlet and a charge pump fluid outlet, a first fluid conduit in fluid communication with the subsea fluid reservoir and the charge pump fluid inlet, a second valve disposed intermediate the subsea fluid reservoir and the charge pump fluid inlet and in fluid communication with the first fluid conduit where the second valve is configured to prevent pressure from entering the subsea fluid reservoir, a second fluid conduit in fluid communication with the charge pump fluid outlet, a feedback loop comprising a first feedback fluid conduit in fluid communication with the charge pump fluid inlet and with the first fluid conduit, a second feedback fluid conduit in fluid communication with the charge pump fluid outlet and the second fluid output and a first valve in fluid communication with the charge pump fluid outlet and the charge pump fluid inlet and configured to prevent over-pressurization of an inlet circuit, the first valve in fluid communication with the first feedback fluid conduit and the second feedback fluid conduit and disposed intermediate the first feedback fluid conduit and the second feedback fluid conduit, and a controller which comprises a housing, a power source operatively in communication with the charge pump and controls disposed within the housing where the controls are operatively in communication with the charge pump, the method comprising:
a. providing a fluid to the bladder at a first fluid pressure;
b. using the fluid charging system to provide protection for the subsea fluid reservoir and inlet conditions of the subsea pump;
c. using the second valve to protect the subsea fluid reservoir from pressure leaking back; and
d. using the feedback loop to protect inlet conditions of the subsea pump by setting the feedback loop valve to open near the maximum inlet condition.

17. The method of claim 16, further comprising using the feedback loop valve to provide pressure protection in case the first valve is closed and the charge pump is run.

18. The method of claim 16, wherein the charge pump comprises a charge pump configured to overcome a large pressure drop due to a long distance between the subsea fluid reservoir and an inlet to the subsea pump or a large set of restrictions.

19. The method of claim 14, further comprising using the charge pump to directly charge an accumulator to minimize charge pump runtime.
